(19) United States
(12) Patent Application Publication
(10) Pub. No.: US 2011/0229977 A1
(43) Pub. Date: Sep. 22, 2011

(54) CHROMATOGRAPHIC ANALYSIS APPARATUS AND METHOD, AS WELL AS PROGRAM

(75) Inventors: Tomonori NISHIO, Kanagawa-ken (JP); Akira ITO, Kanagawa-ken (JP); Mitsuaki UCHIDA, Kanagawa-ken (JP); Yasunori OHTA, Kanagawa-ken (JP); Katsuya INANA, Kanagawa-ken (JP)

(73) Assignee: FUJIFILM CORPORATION, Tokyo (JP)

(21) Appl. No.: 13/019,891

(22) Filed: Feb. 2, 2011

(30) Foreign Application Priority Data
Mar. 16, 2010 (JP) 058777/2010

(51) Int. Cl. G01N 30/02; G01N 21/75

(52) U.S. Cl. 436/161; 422/400

(57) ABSTRACT

Testing of a test article based on a color development state of a test area is achieved in an easy manner. A sample is deposited on a spreading layer of a test piece, and the test piece is loaded in a loading port of a chromatographic analysis apparatus. After a preset time has elapsed, color development states of the test area and a control area in an observation window are read as an image. A preprocessing unit applies preprocessing to the image, and then, spatial frequency components of the image are calculated. Then, pattern information is generated based on the spatial frequency components, and the pattern information is displayed on an information output unit.

### BACKGROUND OF THE INVENTION

1. Field of the Invention

The present invention relates to a chromatographic analysis apparatus and a chromatographic analysis method, as well as a chromatographic analysis program, used to test a test article in a sample.

2. Description of the Related Art

In recent years, many devices for testing a test article using immuno-chromatography, where a sample solution possibly containing the test article is fed onto a test piece, have been developed for testing extracorporeal diagnostic agents, toxic substances, etc., in a simple and quick manner. Specifically, a spreading layer formed by a porous material with a first antibody, which binds specifically to a test article (for example, an antigen), being immobilized on a certain area (test line) of the layer is provided. Then, a sample solution containing a mixture of a labeled second antibody, which binds specifically to the test article, and a sample, which may possibly contain the test article, is spread on the spreading layer. Then, an antigen-antibody reaction among the test article, the first antibody and the second antibody occurs on the test line, causing the test line to be colored or develop a color to exhibit a color development state. By observing the color development state of the test line, quantitative or qualitative (negative/positive) measurement as to whether or not the sample solution contains the test article is achieved.

As a measurement apparatus for POCT (Point of Care Testing) for measuring the above-described test piece in a simple manner, a chromatographic measurement apparatus (immuno-chromato-reader) is used (see, for example, Japanese Unexamined Patent Publication No. 2000-266751 and U.S. Patent Application Publication No. 20050009100, which will hereinafter be referred to as Patent Documents 1 and 2, respectively). Patent Document 1 discloses quantitative determination of a test article based on a density value of the test line of the test piece to efficiently test the test piece. Patent Document 2 discloses determination as to whether or not a zone phenomenon occurs based on an amplitude spectrum shape, which is provided by applying discrete Fourier transform to measurement data at a zone on the test line having the maximum optical time rate of change.

Even using the chromatographic measurement apparatuses as disclosed in Patent Documents 1 and 2, however, it is still not easy to determine the presence of the test article based on the density when the amount of the test article is small and the density of the test line is low.

### SUMMARY OF THE INVENTION

In view of the above-described circumstances, the present invention is directed to providing a chromatographic analysis apparatus and a chromatographic analysis apparatus method, as well as a chromatographic analysis apparatus program, which allow testing a test article in an easy manner based on a color development state of a test area.

An aspect of the chromatographic analysis apparatus of the invention is a chromatographic analysis apparatus for analyzing a color development state of a test piece, the test piece including a spreading layer, on which a sample solution is spread, a test area, which reacts with a test article in the sample solution to develop a color, formed on the spreading layer, and a control area, which develops a color when the sample solution has passed through the control area, the chromatographic analysis apparatus including: reading means for reading a color development state of the test area as an image; frequency processing means for applying frequency conversion processing to the image read by the reading means to calculate spatial frequency components; and pattern generating means for generating pattern information using the spatial frequency components for the individual frequencies calculated by the frequency processing means.

An aspect of the chromatographic analysis method of the invention is a chromatographic analysis method of analyzing a color development state of a test piece, the test piece including a spreading layer, on which a sample solution is spread, a test area, which reacts with a test article in the sample solution to develop a color, formed on the spreading layer, and a control area, which develops a color when the sample solution has passed through the control area, the chromatographic analysis method including: reading a color development state of the test area as an image; applying frequency conversion processing to the image to calculate spatial frequency components; and generating and outputting pattern information using the calculated spatial frequency components.

An aspect of chromatographic analysis program of the invention is a chromatographic analysis program for causing a computer to carry out analysis of a color development state of a test piece including a spreading layer, on which a sample solution is spread, a test area, which reacts with a test article in the sample solution to develop a color, formed on the spreading layer, and a control area, which develops a color when the sample solution has passed through the control area, the chromatographic analysis program including the procedures of: reading a color development state of the test area as an image; applying frequency conversion processing to the image to calculate spatial frequency components; and generating and outputting pattern information using the calculated spatial frequency components.

The test piece may be any test piece as long as the test area thereof exhibits a color development state when there is a test article. For example, the test piece may be one using chromatography, in particular, immuno-chromatography, where immunoassay using an antigen-antibody reaction, in particular, is applied to chromatography. Further, the pattern shape of the test area and the control area is not particularly limited. For example, the test area and the control area may be in the form of lines, or may be formed to have a predetermined pattern. The test piece may be subjected to amplification, or may be one that does not require amplification.

The color development state herein refers to a state where the test area develops a color or changes color when there is a test article, or where the control area develops color or changes color when there is a sample solution. The density value may be any value that represents an intensity of a developed color or a level of change of color of the color development state. The reading means may have any configuration as long as it reads the color development state as density values. For example, the reading means may use an image pickup device to obtain an image of the test piece, or may include light receiving elements that receive reflected light from the test piece when light is applied to the test piece. Further, the reading means may read a change of density of the color development state as the density value, or may read an intensity of light (fluorescence) of a predetermined wavelength as the density value.

The reading means may read only an image of the test area, or may read an image of an area containing the test area and the control area. In this case, the frequency processing means applies the frequency conversion processing to the image containing the test area and the control area.

The frequency processing means may use any known technique, such as Fourier transform, discrete Fourier transform, or wavelet transform, to convert the image into the spatial frequency components.

Further, the frequency processing means may apply the frequency conversion processing to the entire image read by the reading means, or to an analysis area, which is extracted from the image such that the test area is located on one end side and the control area is located on the other end side of the analysis area.

The pattern generating means may use any technique to generate the pattern information based on values of the spatial frequency components. For example, the pattern generating means may generate and output a power spectrum representing amplitudes for the individual frequencies as the pattern information, or may have a function to generate a pattern image that represents the spatial frequency components for the individual frequencies with different colors by providing the pattern image with the different colors depending on values of the spatial frequency components.

The chromatographic analysis apparatus may include preprocessing means for applying preprocessing to the image read by the reading means. For example, the preprocessing means may convert each pixel value of the image into 0 if the pixel value is not larger than a predetermined threshold value, and convert each pixel value into a difference value between the pixel value and the threshold value if the pixel value is larger than the predetermined threshold value. Alternatively, the preprocessing means may convert each pixel value of the image into 0 if the pixel value is not larger than a predetermined threshold value, and convert each pixel value into a prescribed pixel value if the pixel value is larger than the predetermined threshold value.

According to the chromatographic analysis apparatus, the chromatographic analysis method and the chromatographic analysis program of the invention, the color development state of the test piece including the spreading layer, on which the sample solution is spread, the test area formed on the spreading layer to react with the test article in the sample solution and develop a color, and the control area to develop a color when the sample solution has passed therethrough are analyzed, and the color development state of the test area is read as the image. Then, the frequency conversion processing is applied to the image to calculate the spatial frequency components, and the calculated spatial frequency components are used to generate the pattern information. In this manner, the color development state of the test area can clearly be recognized based on the pattern information even when the concentration of the test article in the sample solution is low and it is not easy to carry out determination based on the density of the test area, and such a situation that a test result is regarded as false-negative can be prevented.

In the case where the pattern generating means has the function to generate the pattern image, in which the spatial frequency components for the individual frequencies are represented by different colors, by providing the pattern image with the different colors depending on the values of the spatial frequency components, quantitative or qualitative determination of the test article can be achieved in a more accurate and efficient manner when compared to determination based on the density of the test area.

In the case where the reading means reads an image of an area containing the test area and the control area, and the frequency processing means applies the frequency conversion processing to the image containing the test area and the control area, abnormality (if any) of in the test can also be recognized based on the pattern information, i.e., based on a change of the frequency components due to the density of the control area.

In the case where the pattern generating means generates the power spectrum representing amplitudes for the individual frequencies as the pattern information, quantitative or qualitative determination of the test article can be achieved in a more accurate and efficient manner when compared to determination based on the density of the test area.

In the case where the preprocessing means which converts each pixel value of the image P into 0 if the pixel value is not larger than a predetermined threshold value, and converts each pixel value into a difference value between the pixel value and the threshold value if the pixel value is larger than the predetermined threshold value is further provided, influence of noise components due to the background, etc., exerted on the pattern information can be minimized. In the case where the preprocessing means which has a function to convert each pixel value of the image P into 0 if the pixel value is not larger than a predetermined threshold value, and convert each pixel value into a prescribed pixel value if the pixel value is larger than the predetermined threshold value is further provided, influence of noise components due to the background, etc., exerted on the pattern information can be minimized.

In the case where determination means, which determines positive or negative or determines a level of positivity by calculating a color development level of the test area based on characteristics of the spatial frequency components for the individual frequencies is further be provided, qualitative or quantitative determination can automatically be achieved based on the spatial frequency components in an accurate manner even when the concentration of the test article in the sample solution is low and it is not easy to carry out determination based on the density of the test area.

### BRIEF DESCRIPTION OF THE DRAWINGS

FIG. 1 is a schematic structural diagram illustrating a preferred embodiment of a chromatographic analysis apparatus of the present invention,

FIG. 2 is a schematic diagram showing one example of a test piece to be read by the chromatographic analysis apparatus,

FIG. 3 is a schematic diagram showing one example of the test piece to be read by the chromatographic analysis apparatus,

FIG. 4 is a block diagram illustrating a preferred embodiment of the chromatographic analysis apparatus shown in FIG. 1,

FIG. 5 is a diagram illustrating an image read by a reading means shown in FIG. 4,

FIG. 6 is a graph showing one example of pixel values subjected to preprocessing at a preprocessing means shown in FIG. 4,

FIG. 7 is a graph showing one example of pixel values subjected to preprocessing at the preprocessing means shown in FIG. 4,

FIG. 8 is a graph showing one example of pixel values subjected to preprocessing at the preprocessing means shown in FIG. 4,

FIG. 9 is a schematic diagram showing one example of a pattern image generated at a pattern generating means shown in FIG. 4,

FIG. 10 is a schematic diagram showing one example of a pattern image generated at the pattern generating means shown in FIG. 4,

FIG. 11 is a schematic diagram showing one example of a pattern image generated at the pattern generating means shown in FIG. 4,

FIG. 12 is a schematic diagram showing one example of a pattern image generated at the pattern generating means shown in FIG. 4, and

FIG. 13 is a flow chart illustrating a preferred embodiment of a chromatographic analysis method of the invention.

### DESCRIPTION OF THE PREFERRED EMBODIMENTS

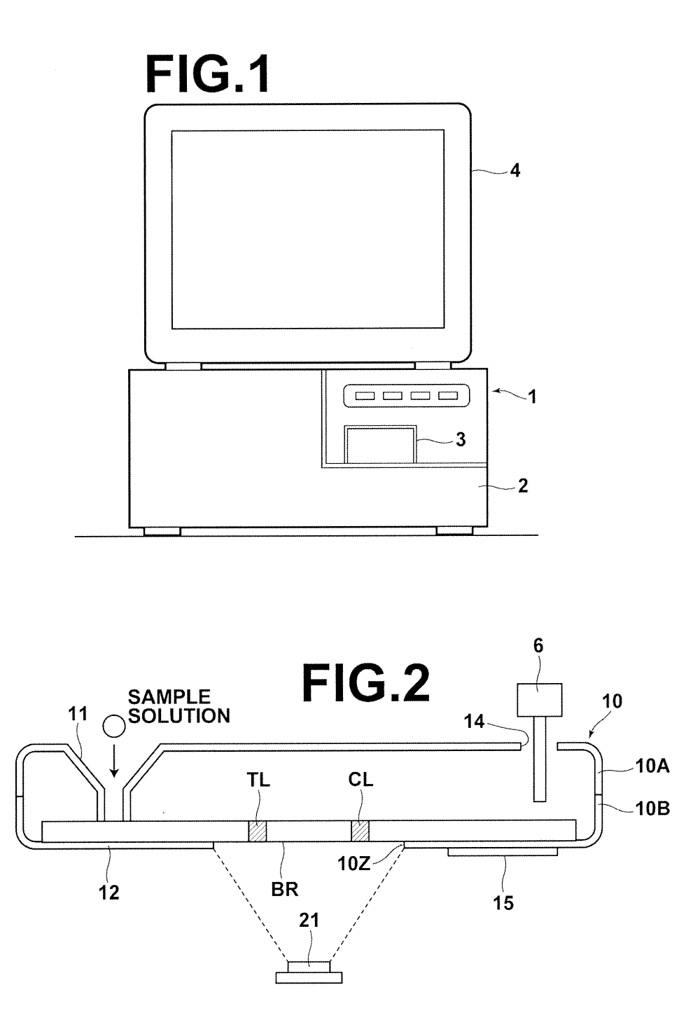

Hereinafter, an embodiment of the present invention will be described in detail with reference to the drawings. FIG. 1 is a schematic structural diagram of a chromatographic analysis apparatus 1 of the invention. The chromatographic analysis apparatus 1 reads a test piece 10 for detecting a test article using, for example, an immuno-chromatography technique. The chromatographic analysis apparatus 1 includes a housing 2, a device loading port 3, an information input/output means 4, etc. The test piece with a sample solution deposited thereon is loaded in the device loading port 3, and a color development reaction occurring on the test piece 10 is optically read. Then, a result of reading is outputted to the information input/output means 4. The information input/output means 4 is an operation panel which is formed, for example, by a liquid crystal touch panel. The user can input basic settings for the measurement via the operation panel.

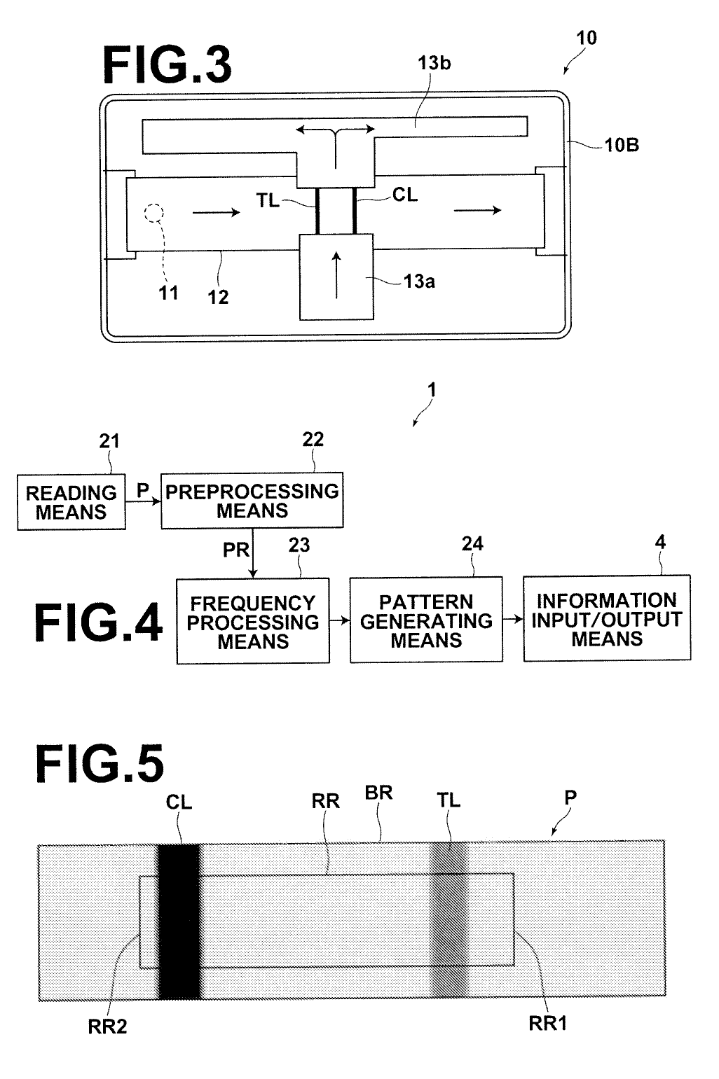

FIGS. 2 and 3 are schematic diagrams showing one example of the test piece 10 to be read by the chromatographic analysis apparatus 1. The test piece 10 used in the invention may any test pieces of known techniques, such as those disclosed in Japanese Unexamined Patent Publication Nos. 2009-139256 and 2007-064766. Further, the test piece 10 described in this embodiment is a test piece which allows so-called amplification; however, a test piece which is not subjected to amplification may be used as the test piece 10.

The test piece 10 is a device for carrying out a quantitative or qualitative (negative/positive) test of a test article using immuno-chromatography, where the test article (a predetermined antigen) is labeled to be visually recognizable. A sample solution containing a mixture of a sample, which may possibly contain the test article, and a labeled material (a second antibody) is deposited on the test piece 10.

The test piece 10 includes an upper case 10A, a lower case 10B and a spreading layer 12, where the spreading layer 12 is contained in the upper case 10A and the lower case 10B. The upper case 10A includes a through hole 11, through which the sample solution is deposited on the spreading layer 12 from outside, and a through hole 14, through which an amplifying solution is deposited on the spreading layer 12. The lower case 10B includes the spreading layer 12 fixed thereon, and an observation window 10Z, through which the quantitative or qualitative measurement of the test article is observed. Further, the lower case 10B includes, on the surface thereof, an information storing means 15, such as a text information, a bar-code, an IC tag, or the like, which records information (such as a name) to identify the sample, information of time required for reaction, etc.

The spreading layer 12 is formed by an absorptive material, such as cellulose filter paper, glass fiber or polyurethane. The sample solution deposited on the spreading layer 12 flows in one direction due to the capillary action. The spreading layer 12 includes a test area TL and a control area CL. On the test area TL, a first antibody, which has specificity to the test article (antibody), is immobilized in a line (test line). When the test article is present on the test area TL, a combination of the first antibody, the test article and the second antibody is formed and a color is developed in the line. On the control area CL, a reference antigen (or antibody), which reacts with the labeled antibody, is immobilized. When the reference antigen (or antibody) reacts with the labeled antibody in the sample solution, a color is developed in a line. By checking the color development state of the control area CL, whether or not the sample solution has passed through the test area TL and the control area CL can be determined.

Further, the test piece 10 includes cleaning layers 13a and 13b that are disposed on opposite sides of the test area TL and the control area CL in the vertical direction (a direction substantially perpendicular to the direction of the flow path of the sample solution). The cleaning layers 13a and 13b form a flow path of a cleaning liquid for cleaning the test area TL and the control area CL. The cleaning layers 13a and 13b are formed by a material of the same sort as that forming the spreading layer 12. The cleaning liquid is stored on the cleaning layer 13a side (not shown). After the reactions at the test area TL and the control area CL have been completed, the cleaning layer 13a is pressed by the chromatographic analysis apparatus 1. Then, the cleaning liquid flows from the cleaning layer 13a to the cleaning layer 13b due to the capillary action, and the cleaning liquid flows to the test area TL and the control area CL that are present between the cleaning layers 13a and 13b. With this, the labeled antibody that has not form immune complexes on the test area TL and the control area CL is removed.

The upper case 10A includes the through hole 14, through which the amplifying solution containing metal ions (such as silver colloid) is spread on the spreading layer 12 from the amplification processing means 6 in the housing 2. After the cleaning with the cleaning liquid, the amplifying solution is spread on the spreading layer 12 and the metal ions bind to the immune complexes formed on the test area TL and the control area CL to amplify the color development state.

FIG. 4 is a block diagram illustrating a preferred embodiment of the chromatographic analysis apparatus of the invention. The chromatographic analysis apparatus 1 shown in FIG. 4 includes a reading means 21, a preprocessing means 22, a frequency processing means 23 and a pattern generating means 24. The reading means 21 reads the color development states at the test area TL and the control area CL through the observation window 10Z as an image P, as shown in FIG. 5. The reading means 21 is formed by an image pickup device, such as a CCD or CMOS. The image P read by the reading means 21 may have grayscale values (density values), values of R, G and B components, or values of a predetermined color (wavelength component), such as fluorescence, as the density values. The reading means 21 is not limited to an image pickup device, and may be any other device including light receiving elements that receive reflected light or fluorescence through the observation window 10Z.

Further, when the reading means 21 reads the image P through the observation window 10Z, the reading means 21 extracts an analysis area RR, which contains the test area TL located on one end side RR1 thereof and the control area CL located on the other end side RR2 thereof. It should be noted that the test area TL and the control area CL are formed at predetermined positions on the test piece 10, and the test piece 10 is positioned at a predetermined position in the apparatus 1 via the device loading port 3. Therefore, the reading means 21 extracts a predetermined area as the analysis area RR, and outputs the analysis area RR as an area to be subjected to frequency conversion processing. With this, abnormality (if any) on the control area CL, for example, can also be recognized from pattern information PP.

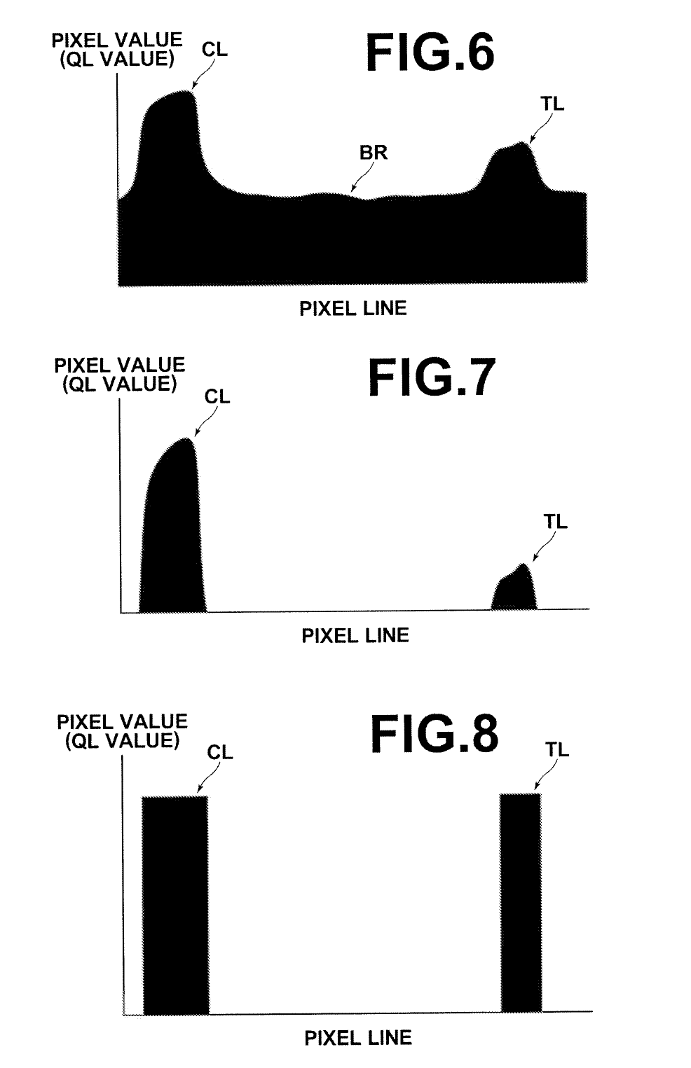

The preprocessing means 22 applies preprocessing to the image P. For example, the preprocessing means 22 calculates a representative pixel value, such as mean value, median value or mode value, for each pixel line, which is parallel to the test area TL and the control area CL. Then, representative pixel values for each one-dimensional pixel line, as shown FIG. 6, are obtained. At this time, the preprocessing means 22 may reduce the number of representative pixels from those for 512 lines to those for 16 lines, for example, by compressing the pixel lines in the analysis area RR.

Further, the preprocessing means 22 has a function to apply thresholding to the above-described representative pixel values. For example, as shown in FIG. 7, if each representative pixel value of the image P is not larger than a predetermined threshold value, the preprocessing means 22 converts the representative pixel value into 0. If each representative pixel value is larger than the predetermined threshold value, the preprocessing means 22 may use a difference value between the representative pixel value and the threshold value as a new representative pixel value (background correction). Alternatively, as shown in FIG. 8, if each pixel value is larger than the predetermined threshold value, the preprocessing means 22 may carry out normalization with using a prescribed pixel value as a new representative pixel value. This can minimize influence of noise components in an area BR other than the test area TL and the control area CL exerted on the pattern information PP.

The frequency processing means 23, shown in FIG. 4, applies frequency conversion processing to the image P read by the reading means 21 to calculate spatial frequency components. The frequency processing means 23 calculates a spatial frequency component for each frequency by applying one-dimensional fast Fourier transform (FFT) to the representative pixel values in the analysis area RR preprocessed by the preprocessing means 22. Although the case where the frequency processing means 23 applies the frequency conversion processing to the preprocessed analysis area RR (see FIGS. 6 to 8) is described as an example, the frequency conversion processing may be applied to the analysis area RR before preprocessed.

Further, although the case where the frequency processing means 23 applies the one-dimensional fast Fourier transform is described as an example, two-dimensional Fourier transform may be applied. In this case, the preprocessing means 22 needs not to calculate the representative pixel values for each pixel line, and calculates spatial frequency components in a (u,v) space. The frequency processing means 23 may apply any other frequency conversion processing, such as wavelet transform, in place of Fourier transform. Still further, although the case where the frequency processing means 23 uses the one-dimensional Fourier transform to calculate the calculable components for all the frequencies is described in this embodiment, the frequency processing means 23 may determine positive or negative, or may determine a level of positivity with using results of calculation of Fourier coefficients for a certain frequency.

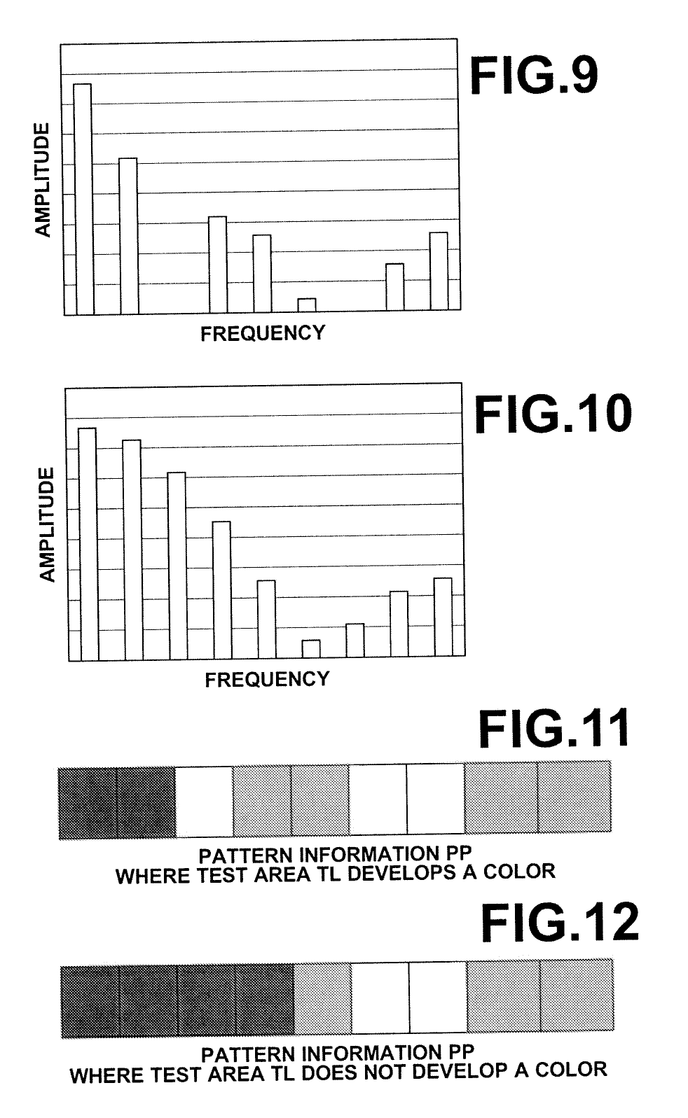

The pattern generating means 24 generates the pattern information PP using the spatial frequency components calculated by the frequency processing means 23. For example, the frequency processing means 23 calculates a power spectrum distribution based on the one-dimensional Fourier transform. Then, in the case where both the control area CL and the test area TL are in the color development state, the power spectrum shown in FIG. 9 is generated as the pattern information PP. In the case where only the control area CL is in the color development state, the power spectrum shown in FIG. 10 is generated as the pattern information PP.

Further, the pattern generating means 24 has a function to generate a pattern image, which is provided with different colors for the different spatial frequency components (amplitude values). Specifically, the pattern generating means 24 stores, in advance, different colors or grayscale values corresponding to different amplitude values, and generates the pattern image, as shown in FIGS. 11 and 12, in which the amplitude of each frequency is represented by a certain color. It should be noted that FIG. 11 shows the pattern image in the case where both the control area CL and the test area TL are in the color development state, and FIG. 12 shows the pattern image in the case where only the control area CL is in the color development state.

The information input/output means 4 has a function to display any or all of the above-described image P (see FIG. 5), the pixel values of the image P (see FIGS. 6 to 8) and the pattern information (see FIGS. 9 to 12). With this, the user can carry out quantitative or qualitative determination of the test article using all the above-described information.

As described above, by generating the pattern information PP after the frequency conversion processing is applied to the image P representing the color development state, quantitative or qualitative determination based on the color development state can easily be achieved. That is, in the case where the determination is carried out through visual observation of the density of the test area TL, as in the conventional techniques, it is not easy to determine the color development state through visual observation when the density is low. By generating the pattern information after the frequency conversion, the color development state of the test area TL can accurately be seen from the pattern information even when the density is low, thereby efficiently achieving quantitative or qualitative measurement of the test article.

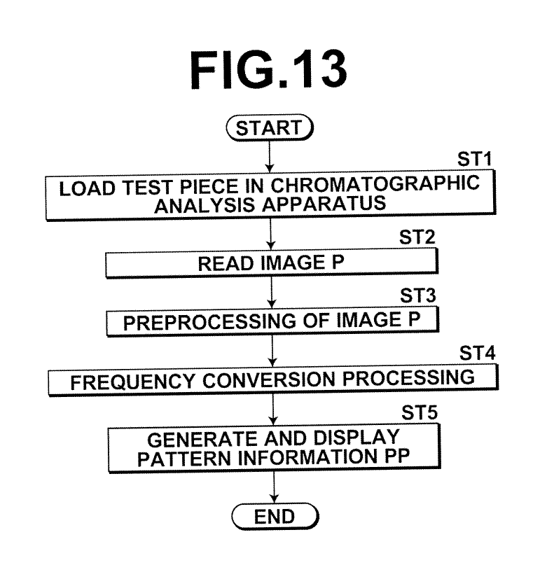

FIG. 13 is a flow chart illustrating a preferred embodiment of a chromatographic analysis method of the invention. Now, the chromatographic analysis method is described with reference to FIGS. 1 to 13. First, a sample is deposited on the spreading layer 12 of the test piece 10 shown in FIGS. 2 and 3, and the test piece is loaded in the loading port 3 of the chromatographic analysis apparatus 1 (step ST1). Then, the chromatographic analysis apparatus 1 detects that the test piece 10 is loaded and starts the measurement. Then, after a set time, which is set in advance depending on the type of the sample solution, has elapsed, the reading means 21 reads the color development states of the test area TL and the control area CL in the observation window 10Z as the image P (step ST2, see FIG. 5). Then, the preprocessing means 22 applies preprocessing to the image P (step ST3), and the frequency processing means 23 calculates the spatial frequency components (step ST4).

Thereafter, the pattern generating means 24 generates the pattern information (pattern image) PP based on the spatial frequency components, and the pattern information PP is displayed on the information input/output means 4 (step ST5). At this time, the information input/output means 4 simultaneously displays the image P and the density values with the pattern information, and the user makes qualitative (positive/negative) determination of the test article based on the display on the information input/output means 4.

According to the above-described embodiment, the color development state of the test piece including the spreading layer 12, on which the sample solution is spread, the test area TL formed on the spreading layer 12 to react with the test article in the sample solution and develop a color, and the control area CL to develop a color when the sample solution has passed therethrough are analyzed, and the color development state of the test area TL is read as the image P. Then, the frequency conversion processing is applied to the image P to calculate the spatial frequency components, and the calculated spatial frequency components are used to generate and output the pattern information PP. In this manner, such a situation that a test result is regarded as false-negative can be prevented even when the concentration of the test article in the sample solution is low.

Further, as shown in FIGS. 11 and 12, in the case where the pattern generating means 24 has the function to generate, as the pattern information, the pattern image PP, in which the spatial frequency components for the individual frequencies are represented by different colors, by providing the pattern image with the different colors depending on the values of the spatial frequency components, quantitative or qualitative determination of the test article can be achieved in a more accurate and efficient manner when compared to determination based on the density of the test area TL.

Still further, as shown in FIG. 7, in the case where the preprocessing means 22 converts each pixel value of the image P into 0 if the pixel value is not larger than a predetermined threshold value, and converts each pixel value into a difference value between the pixel value and the threshold value if the pixel value is larger than the predetermined threshold value, influence of noise components due to the background, etc., exerted on the pattern information can be minimized.

Alternatively, as shown in FIG. 8, in the case where the preprocessing means 22 has a function to convert each pixel value of the image P into 0 if the pixel value is not larger than a predetermined threshold value, and convert each pixel value into a prescribed pixel value if the pixel value is larger than the predetermined threshold value, influence of noise components due to the background, etc., exerted on the pattern information can be minimized.

Further, as shown in FIGS. 9 and 10, in the case where the pattern generating means 24 generates, as the pattern information PP, the power spectrum representing amplitudes for individual frequencies, quantitative or qualitative determination of the test article can be achieved in a more accurate and efficient manner when compared to determination based on the density of the test area TL.

The present invention is not limited to the above-described embodiment. For example, although the test piece has a single determination line in the above-described embodiment, the test piece may have two or more determination lines. In this case, the analysis area RR is set to contain two or more test areas TL and control areas CL, and the pattern information is generated after the frequency conversion processing.

Further, although the pattern generating means 24 generates the pattern image based on the power spectrum in the above-described embodiment, the pattern generating means 24 may generate the pattern image using only real number parts (cos (ω)) components).

Still further, although the pattern information is generated and displayed in the above-described embodiment, determination means, which determines positive or negative or a level of positivity by calculating a color development level of the test area TL based on characteristics of the spatial frequency components for the individual frequencies generated by the frequency processing means 23, may further be provided. For example, the determination means may recognize the pattern using a neural network, a boosting algorithm, or the like, which is generated through a learning process using teacher data having feature quantities (feature vectors) formed by known spatial frequency components or pattern information for positive and negative cases, so that the determination means automatically carries out qualitative determination (negative/positive) or qualitative determination (a level of positivity) of the test article when unknown spatial frequency components are inputted or unknown pattern information is inputted. With this, qualitative or quantitative determination can automatically be carried out based on the spatial frequency components in an accurate manner even when the concentration of the test article in the sample solution is low and it is not easy to carry out determination based on the density of the test area.

Yet further, although the configuration of the chromatographic analysis apparatus 1 shown in FIG. 4 is implemented using a DSP, etc., the chromatographic analysis apparatus 1 may obtain the image P read by the reading means 21 and analyze the image P using a personal computer, or the like. In this case, the configuration of the chromatographic analysis apparatus 1 shown in FIG. 4 is implemented by executing a chromatographic analysis program, which is stored in an auxiliary storage apparatus of the computer (such as a personal computer), on the computer. The chromatographic analysis program may be stored in an information storage medium, such as a CD-ROM, or distributed via a network, such as the Internet, to be installed on the computer.

What is claimed is:

1. A chromatographic analysis apparatus for analyzing a color development state of a test piece, the test piece including a spreading layer, on which a sample solution is spread, a test area, which reacts with a test article in the sample solution to develop a color, formed on the spreading layer, and a control area, which develops a color when the sample solution has passed through the control area, the chromatographic analysis apparatus comprising:
rearing means for reading a color development state of the test area as an image;
frequency processing means for applying frequency conversion processing to the image read by the reading means to calculate spatial frequency components; and
pattern generating means for generating pattern information using the spatial frequency components for the individual frequencies calculated by the frequency processing means.

2. The chromatographic analysis apparatus as claimed in claim 1, wherein the pattern generating means generates, as the pattern information, a pattern image representing the spatial frequency components for the individual frequencies with different colors by providing the pattern image with the different colors depending on values of the spatial frequency components.

3. The chromatographic analysis apparatus as claimed in claim 1, wherein the pattern generating means generates, as the pattern information, a power spectrum representing amplitudes for the individual frequencies.

4. The chromatographic analysis apparatus as claimed in claim 1, wherein the reading means reads the image of an area containing the test area and the control area, and the frequency processing means applies frequency conversion processing to the image containing the test area and the control area.

5. The chromatographic analysis apparatus as claimed in claim 1, further comprising preprocessing means for converting each pixel value of the image into 0 if the pixel value is not larger than a predetermined threshold value, and converting each pixel value into a difference value between the pixel value and the threshold value if the pixel value is larger than the predetermined threshold value,
wherein the frequency processing means applies frequency conversion processing to the preprocessed image.

6. The chromatographic analysis apparatus as claimed in claim 1, further comprising preprocessing means for converting each pixel value of the image into 0 if the pixel value is not larger than a predetermined threshold value, and converting each pixel value into a prescribed pixel value if the pixel value is larger than the predetermined threshold value,
wherein the frequency processing means applies frequency conversion processing to the preprocessed image.

7. The chromatographic analysis apparatus as claimed in claim 1, further comprising information output means for displaying the image and the pattern information on a single display screen.

8. The chromatographic analysis apparatus as claimed in claim 1, wherein the reading means reads a color development state of the test area from the test piece amplified with an amplifying agent.

9. The chromatographic analysis apparatus as claimed in claim 1, further comprising determination means for calculating a color development level of the test area based on characteristics of the spatial frequency components for the individual frequencies generated by the frequency processing means to determine positive or negative or determine a level of positivity.

10. A chromatographic analysis method of analyzing a color development state of a test piece, the test piece including a spreading layer, on which a sample solution is spread, a test area, which reacts with a test article in the sample solution to develop a color, formed on the spreading layer, and a control area, which develops a color when the sample solution has passed through the control area, the chromatographic analysis method comprising:
reading a color development state of the test area as an image;
applying frequency conversion processing to the image to calculate spatial frequency components; and
generating and outputting pattern information using the calculated spatial frequency components.

11. A computer-readable recording medium containing a chromatographic analysis program for causing a computer to carry out analysis of a color development state of a test piece, the test piece including a spreading layer, on which a sample solution is spread, a test area, which reacts with a test article in the sample solution to develop a color, formed on the spreading layer, and a control area, which develops a color when the sample solution has passed through the control area, the chromatographic analysis program comprising the procedures of:
reading a color development state of the test area as an image;
applying frequency conversion processing to the image to calculate spatial frequency components; and
generating and outputting pattern information using the calculated spatial frequency components.
